(19) United States
(12) Patent Application Publication
(10) Pub. No.: US 2008/0218787 A1
(43) Pub. Date: Sep. 11, 2008

(54) IMAGE FORMING APPARATUS AND IMAGE FORMING METHOD

(75) Inventor: Souichi Izumisawa, Tagata-gun (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/681,896

(22) Filed: Mar. 5, 2007

(51) Int. Cl. G06F 3/12

(52) U.S. Cl. 358/1.15

(57) ABSTRACT

In an image formation instructing station in an example of the invention, an image forming apparatus has a receiving unit configured to receive first facsimile data affixed with first transmission station identification data, a storing unit configured to store a transfer box in which an identification code based on one or more transmission station identification data and a transfer destination for facsimile data corresponding to the identification code are set, a searching unit configured to search whether a first identification code based on the first communication station identification data is included in the identification code set in the transfer box stored in the storing unit, and a transferring unit configured to transfer the first facsimile data to the transfer destination when the searching unit finds a second identification code coinciding with the first identification code from the identification code.

### BACKGROUND OF THE INVENTION

1. Field of the Invention

The present invention relates to an image forming apparatus that transfers facsimile data received from the outside.

2. Description of the Related Art

In general, there are known a facsimile having a facsimile function, a multi-function peripheral (MFP) that is an image forming apparatus having the facsimile function, and the like. Among such apparatuses having the facsimile function, there are some apparatuses having a function of transferring received facsimile data to other facsimiles or transferring received facsimile data to other MFPs and PCs using Internet facsimiles (iFAXes) and electronic mails (E-mails) via networks. This transfer of received facsimile data is performed by, for example, F-code relay employing “SUB”.

The F-code relay is as described below. A box to which a predetermined name within twenty digits decided in advance is affixed as a name is created in an apparatus on a reception side as “SUB”. A transfer destination of facsimile data is set in this box. At the time of facsimile transmission, a sender transmits facsimile with “SUB” affixed thereto in an apparatus at a transmission source. The apparatus on the reception side having received the facsimile data affixed with “SUB” transfers the received facsimile data or saves the received facsimile data according to a transfer setting set in the box corresponding to “SUB” affixed to the facsimile data.

In this way, in the transfer of facsimile data according to the F-code relay, at the time of facsimile transmission, the sender has to instruct the apparatus on the reception side to perform an operation set in advance. In other words, unless the sender intentionally inputs “SUB” for transferring the facsimile data to the transfer destination set in advance, it is impossible to cause the apparatus on the reception side to, for example, transfer the received facsimile data.

When the sender desires to transfer facsimile data not affixed with “SUB”, it is possible to provide a transfer setting as a setting unique to the apparatus. When such a setting is performed, the apparatus on the reception side transfers all the facsimile data received to an identical transfer destination set. However, it is impossible to change a transfer destination for each transmission source of facsimile data. This is inconvenient when a facsimile is shared. Therefore, there is a need for an image forming apparatus with which a sender can transfer received facsimile data according to a transmission source of the facsimile data without being conscious that the sender causes a reception side apparatus to transfer the facsimile data at the time of facsimile transmission.

### BRIEF SUMMARY OF THE INVENTION

According to an aspect of the invention, an image forming apparatus has a receiving unit configured to receive first facsimile data affixed with first transmission station identification data, a storing unit configured to store a transfer box in which an identification code based on one or more transmission station identification data and a transfer destination for facsimile data corresponding to the identification code are set, a searching unit configured to search whether a first identification code based on the first communication station identification data is included in the identification code set in the transfer box stored in the storing unit, and a transferring unit configured to transfer the first facsimile data to the transfer destination when the searching unit finds a second identification code coinciding with the first identification code from the identification code.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram schematically showing a network structure in an embodiment of the invention;

FIG. 2 is a block diagram showing a main part structure of an image forming apparatus according to the embodiment of the invention;

FIG. 3 is a diagram showing display in a display unit at the time when a transfer setting is performed in the embodiment of the invention;

FIG. 4 is a diagram showing display in the display unit at the time when a transfer setting is performed in the embodiment of the invention;

FIG. 5 is a diagram showing display in the display unit at the time when a transfer setting is performed in the embodiment of the invention;

FIG. 6 is a diagram showing display in the display unit at the time when a transfer setting is performed in the embodiment of the invention;

FIG. 7 is a diagram showing display in the display unit at the time when a transfer setting is performed in the embodiment of the invention;

FIG. 8 is a diagram showing display in the display unit at the time when a transfer setting is performed in the embodiment of the invention;

FIG. 9 is a diagram showing display in the display unit at the time when a transfer setting is performed in the embodiment of the invention;

FIG. 10 is a diagram showing display in the display unit at the time when a transfer setting is performed in the embodiment of the invention;

FIG. 11 is a diagram showing display in the display unit at the time when a transfer setting is performed in the embodiment of the invention;

FIG. 12 is a table showing a relation between a box and a transfer setting in the embodiment of the invention;

FIG. 13 is a table showing a relation between a box and a transfer setting in the embodiment of the invention; and

FIG. 14 is a flowchart showing a main part of processing executed by a CPU when facsimile data is received in the embodiment of the invention.

### DETAILED DESCRIPTION OF THE INVENTION

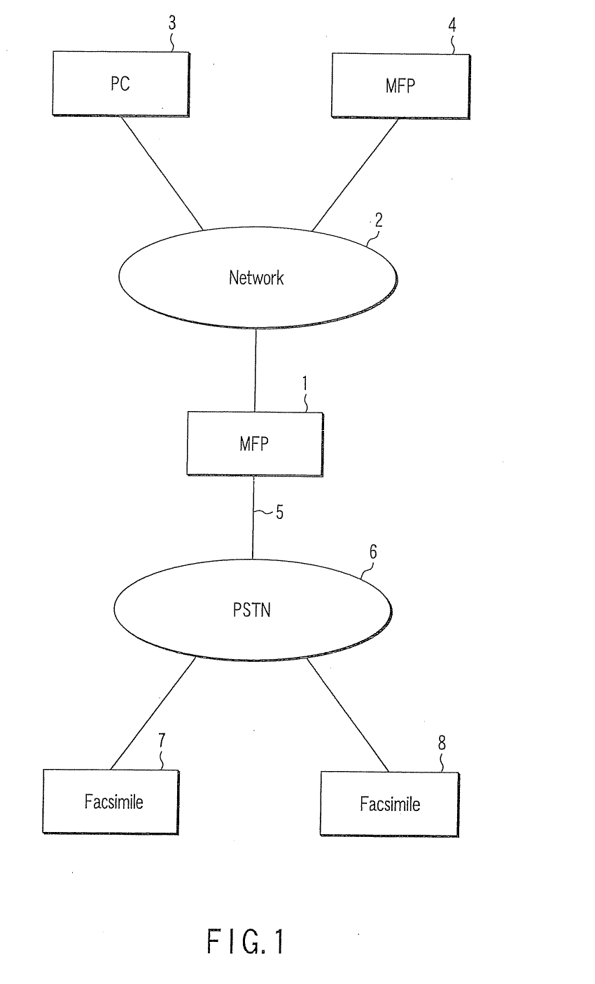

Embodiments of the invention will be explained with reference to the drawings. FIG. 1 is a diagram schematically showing a network structure to which a multi-function peripheral (MFP 1) is connected.

The MFP 1 is a multi-function printer having a facsimile function, a printer function, a copy function, a scanner function, a network function, and the like. As shown in FIG. 1, the MFP 1 is connected to a PC 3 and an MFP 4 via a network 2. An E-mail address on the network of the PC 3 is “xxx@xxx.co.jp”. The network 2 is assumed to be a local area network, although the network may be the Internet. In an explanation of this embodiment, one PC 3 and one MFP 4 are connected to the network 2 to which the MFP 1 is connected. However, the numbers of the PCs 3 and the MFPs 4 are not limited to this.

The MFP 1 is connected to a PSTN 6 via a public switched telephone network (PSTN) subscriber line 5. A facsimile 7 and a facsimile 8 are connected to the PSTN 6. It is assumed that, for example, a telephone number “0331234567” is allocated to the facsimile 7. It is assumed that, for example, a telephone number “0556784321” is allocated to the facsimile 8. When the facsimile 7 transmits facsimile data, for transmission station identification (TSI), the facsimile 7 transmits data indicating a telephone number. The TSI is a transmission station identification signal transmitted in a phase B. The TSI (an option under the ITU recommendation) is used by being displayed on a display or printed on a reception management report in an apparatus on a reception side. In the following explanation, facsimiles connected to the PSTN 6 are two facsimiles, namely, the facsimile 7 and the facsimile 8. However, the number of the facsimiles is not limited to this.

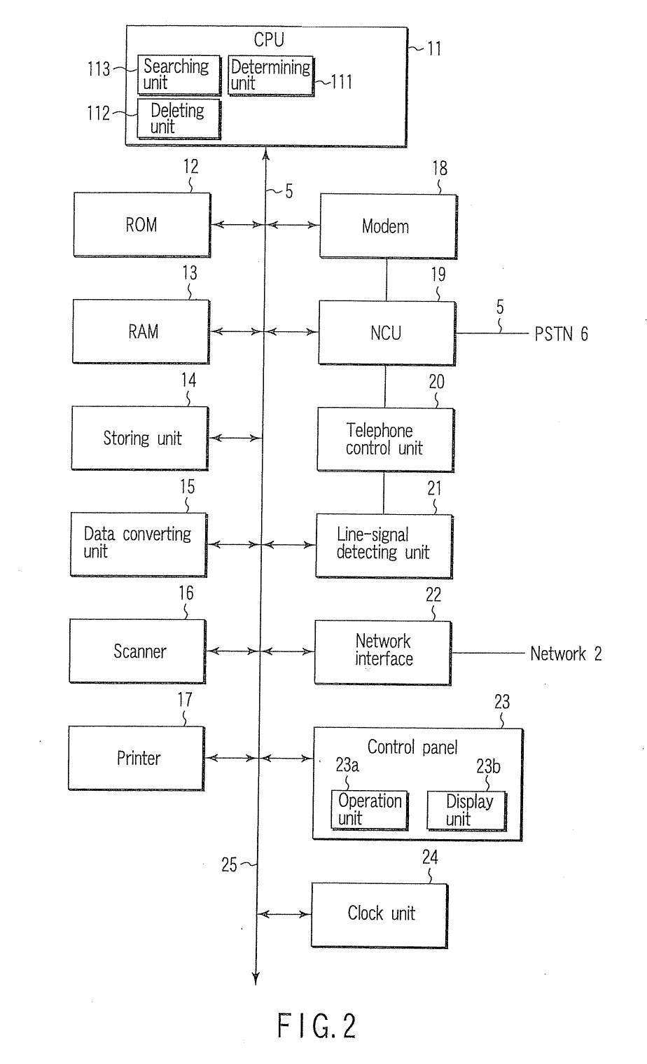

FIG. 2 is a block diagram showing a main part structure of the MFP 1. The MFP 1 has a CPU 11, a ROM 12, a RAM 13, a storing unit 14, a data converting unit 15, a scanner 16, a printer 17, a modem 18, an NCU 19, a telephone control unit 20, a line-signal detecting unit 21, a network interface 22, a control panel 23, and a clock unit 24.

The CPU 11, the ROM 12, the RAM 13, the storing unit 14, the data converting unit 15, the scanner 16, the printer 17, the modem 18, the NCU 19, the line-signal detecting unit 21, the network interface 22, the control panel 23, and the clock unit 24 are connected to one another via a bus line 25. The modem 18 and the telephone control unit 20 are connected to the NCU 19. The line-signal detecting unit 21 is connected to the telephone control unit 20.

The CPU 11 performs control processing for collectively controlling the units on the basis of a control program stored in the ROM 12 to realize operations of the MFP 1. The CPU 11 has a determining unit 111, a deleting unit 112, and a searching unit 113. The determining unit 111 determines whether a TSI transfer function is set valid for the MFP 1. The deleting unit 112 extracts only numerals from TSI corresponding to facsimile data received by the MFP 1 (deletes data of spaces, signs, and characters other than numerals). The searching unit 113 searches whether the TSI, from which the data of characters and the like other than numerals are deleted by the deleting unit 112, is set in a TSI transfer box described later, which is stored in the storing unit 14. The TSI transfer box will be described in detail later. The ROM 12 stores the control program and the like for the CPU 11. The RAM 13 is used as a work area and the like for storing various kinds of information required by the CPU 11 to perform various kinds of processing. The storing unit 14 is, for example, a hard disk driving device (HDD). The storing unit 14 temporarily saves image data and stores data concerning various settings such as a setting for a box. The box is created for a predetermined purpose with a name affixed thereto. Details of the box will be described later. The data converting unit 15 applies encoding processing for redundancy compression to image data and performs decoding of image data subjected to encoding for redundancy compression. The scanner 16 performs scanning of a transmission original and generates image data indicating the transmission original. The printer 17 prints an image indicated by the image data on a recording sheet.

The modem 18 modulates image data to generate a facsimile transmission signal and modulates a command given from the CPU 11 to generate a command transmission signal. The modem 18 transmits these transmission signals to the PSTN subscriber line 5 via the NCU 19. The modem 18 demodulates a facsimile transmission signal, which arrives via the PSTN subscriber line 5 and is given via the NCU 19, to reproduce image data and demodulates a command transmission signal to reproduce a command. The PSTN subscriber line 5 stored in the PSTN 6 is connected to the NCU 19. The NCU 19 performs, concerning the PSTN subscriber line 5 connected thereto, state monitoring, processing for calling to a network, and the like. The NCU 19 performs, for example, a setting of a level of a facsimile transmission signal transmitted to the PSTN subscriber line 5. An external telephone is connected to the telephone control unit 20 as required. The line-signal detecting unit 21 receives a signal, which arrives via the PSTN subscriber line 5, via the NCU 19 and the telephone control unit 20 and detects arrival of a predetermined signal.

The network interface 22 is used for connection to the network 2. The network interface 22 performs data transmission via the network 2. The control panel 23 has an operation unit 23a for accepting various instruction inputs to the CPU 11 by a user, a display unit 23b for displaying various kinds of information, which should be reported to the user, under the control by the CPU 11, and the like. The clock unit 24 always performs a timing operation and outputs present time information indicating a present time.

A box created in the storing unit 14 will be explained. The box is created by the user, for example, in cases described below. A box is created for the user to save data of specific documents and images and the like. As a name of the box in this case, for example, a name of the user is affixed. Moreover, a box is created for the user to perform transfer processing (details will be described later) for performing transfer of reception facsimile data using the TSI (hereinafter referred to as a TSI transfer box). In this case, as a name of the TSI transfer box, an arbitrary number is affixed. A telephone number is set in the TSI transfer box. A setting for transferring facsimile data is stored in this TSI transfer box.

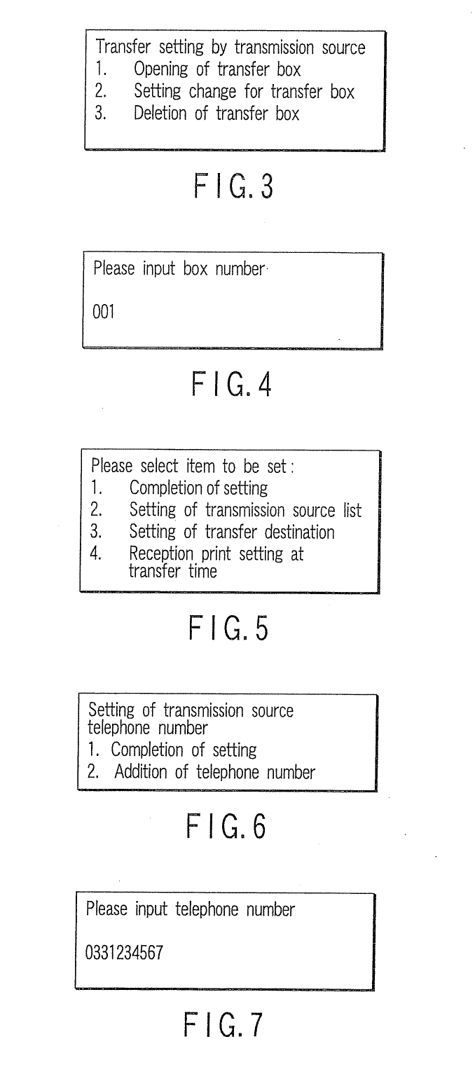

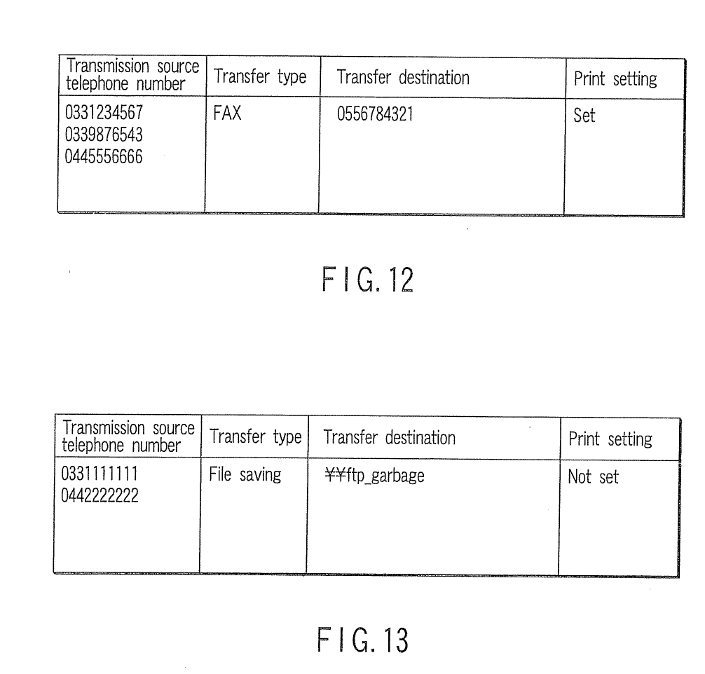

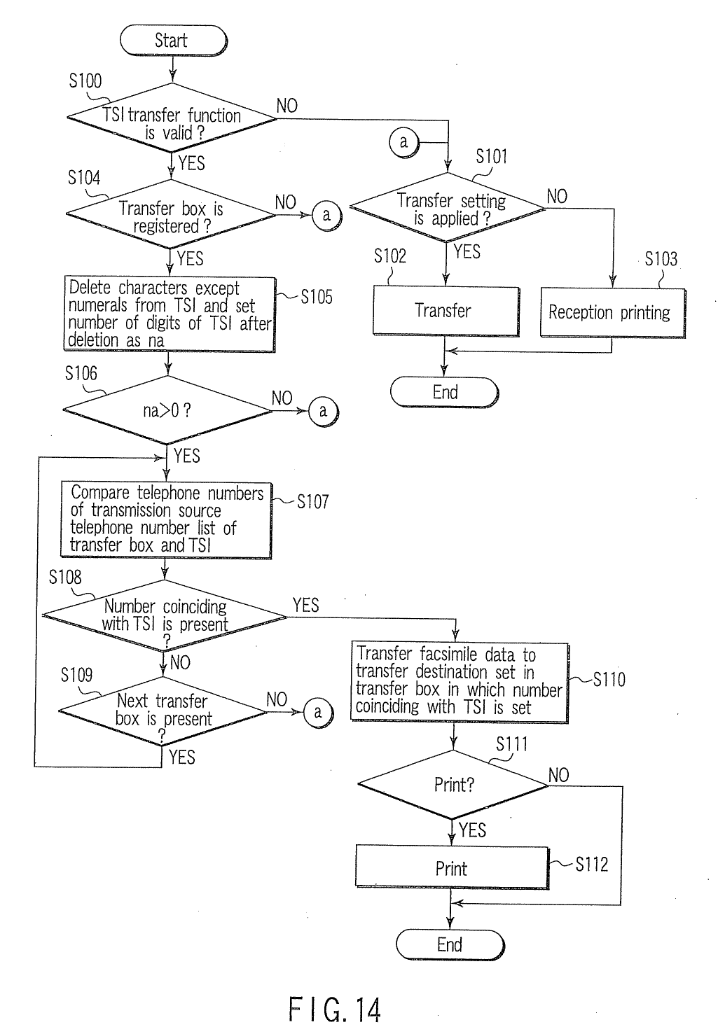

Subsequently, an example of operation in creating a TSI transfer box for transferring facsimile data using TSI will be explained using FIGS. 3 to 13. Concerning the TSI transfer box, as shown in FIG. 12 or FIG. 13, the user sets a transfer source telephone number, a transfer type, a transfer destination, and a print setting.

First, the user operates the operation unit 23a of the control panel 23 and invokes a screen for performing a transfer setting by transfer source on the display unit 23b. Then, as shown in FIG. 3, “1. opening of a transfer box”, “2. setting change for a transfer box”, and “3. deletion of a transfer box” are displayed on the display unit 23b. After selecting “1. opening of a transfer box”, the user sets a TSI transfer box number of a TSI transfer box (shown in FIG. 4). The TSI transfer box number may be arbitrary. For example, serial numbers 001, 002, and the like may be affixed. The user selects “2. setting change for a transfer box” when setting contents are changed and the user desires to change the transfer box setting after opening of the TSI transfer box. The user selects “3. deletion of a transfer box” when setting contents become unnecessary after the opening of the TSI transfer box.

When the user sets a TSI transfer box number, a screen shown in FIG. 5 is displayed on the display unit 23b. On the display unit 23b, “1. completion of a setting”, “2. setting of a transmission source list”, “3. setting of a transfer destination”, and “4. setting of reception printing at the time of transfer” for setting conditions of the TSI transfer box are displayed (FIG. 5). When the user selects “2. setting of a transmission source list”, a screen shown in FIG. 6 is displayed on the display unit 23b. “1. completion of a setting” and “2. addition of a telephone number” are displayed on the display unit 23b as settings of a transmission source telephone number (FIG. 6). When the user selects “2. addition of a telephone number”, a screen shown in FIG. 7 is displayed on the display unit 23b. The user can set a telephone number of a transmission source to which the user desires to transfer facsimile data (FIG. 7). For example, when the user desires to TSI-transfer facsimile data received from a transmission source with a telephone number “033-123-4567”, the user inputs a number “0331234567” (FIG. 7). When the setting is decided, returning to the screen shown in FIG. 6, the user can further perform setting by selecting “1. completion of a setting” when the user ends the setting of the telephone number of the transmission source and selecting “2. addition of a telephone number” when the user further sets a telephone number of a transmission source in the identical TSI transfer box. It is possible to register plural transmission source telephone numbers in the TSI transfer box.

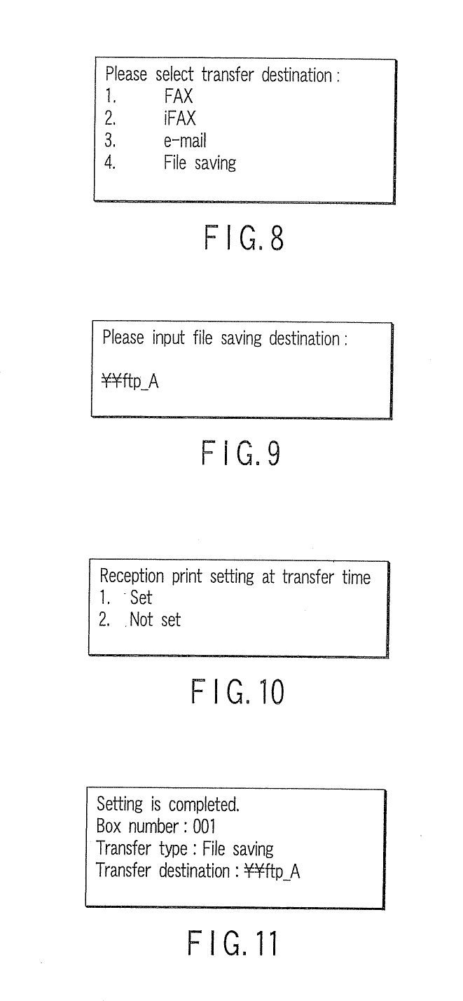

When the user selects “1. completion of a setting” for a setting screen for a transmission source telephone number shown in FIG. 6 and finishes the setting of the telephone number of the transmission source, returning to the screen shown in FIG. 5, the user continues the setting of conditions for the TSI transfer box. When the user selects “3. setting of a transfer destination” in FIG. 5, “1. FAX”, “2. iFAX”, “3. E-mail”, “4. file saving” are displayed on the display unit 23b (FIG. 8). On this setting screen, it is possible to set how facsimile data transmitted from a transmission source should be transferred (FAX/iFAX/e-mail/File saving). When the user selects “4. file saving”, a File saving destination input screen shown in FIG. 9 is displayed on the display unit 23b. The user sets a saving destination of facsimile data as, for example, \\ftp_A. When the user selects any one of “1. FAX”, “2. iFAX”, and “3. E-mail”, a screen for inputting a number and an address of a transfer destination is displayed on the display unit 23b. When the setting of the transfer destination is decided, the screen shown in FIG. 5 is displayed on the display unit 23b. When the user selects “4. reception print setting at transfer time”, a screen for setting “1. Not set” or “2. Set” as reception print setting at transfer time is displayed on the display unit 23b (FIG. 10). As the reception print setting at transfer time, it is possible to set in the MFP 1, simultaneously with transfer, whether facsimile data received by the MFP 1 is printed. When the user selects “1. Not set” and the setting is decided, the screen shown in FIG. 5 is displayed on the display unit 23b. As described above, in the case in which the setting at least required for transfer of facsimile data is performed, when the user selects “1. completion of a setting” on the screen in FIG. 5, a screen shown in FIG. 11 is displayed on the display unit 23b. A message indicating completion of a setting and contents set are displayed in FIG. 11. When the setting described above is performed by the user, a message “setting is completed”, “box number: 001”, “transfer type: file saving”, and “transfer destination: \\ftp_A” are displayed on the display unit 23b. The user can check a transfer setting from the display on this display unit 23b.

When the user performs a setting for the TSI transfer box explained above, the user only has to look at a telephone number of a transmission source described in a reception management report (journal) and set the telephone number in the TSI transfer box. For example, it is possible to easily perform an operation for transferring an order by facsimile from a specific customer to a specific PC. In that case, it is possible to set the TSI transfer box not to perform reception printing at transfer time and impart confidentiality to reception from a specific transmission source. By making it possible to set plural telephone numbers in a transmission source telephone number list set in the TSI transfer box, it is possible to transfer facsimile data from inconsistent transmission sources, which are in an identical trader but telephone numbers owned by which do not have coinciding parts, to one same transfer destination.

FIGS. 12 and 13 are tables showing the TSI transfer box stored in the storing unit 14 and the contents set in the TSI transfer box. FIG. 12 shows a transfer setting of a TSI transfer box number 001. FIG. 13 shows a transfer setting of a TSI transfer box number 999. In FIG. 12, “0301234567”, “0339876543”, and “0445556666” are set as transmission source telephone numbers, “FAX” is set as a transfer type, “055674321” is set as a transfer destination, and “Set” is set as a print setting. This means that, for example, the MFP 1 having received facsimile data from a facsimile 7 allocated with the telephone number “0301234567” transfers the facsimile data to a facsimile 8 allocated with the telephone number “055674321”. The MFP 1 prints the received facsimile data with the printer 17. In FIG. 13, “0331111111” and “0442222222” are set as transmission source telephone numbers, “file saving” is set as a transfer type, “\\ftp_garbage” is set as a transfer destination, and “Not set” is set as a print setting. This means that, for example, the MFP 1 having received facsimile data from the facsimile 7 allocated with the telephone number “0331111111” transfers the facsimile data to, for example, “\\ftp_garbage” of the storing unit 14 of the MFP 1. The MFP 1 does not print the received facsimile data with the printer 17.

The user is capable of setting in advance, by operating the operation unit 23a of the control, a setting for validating or invalidating a transfer function (a TSI transfer function) based on the setting of the TSI transfer box created in this way. In this embodiment, the TSI transfer function is set to be valid. As contents set in the TSI transfer box, in addition to a setting of a transfer type and a transfer destination and a reception setting, a setting on whether a list indicating that data is transferred should be outputted at transfer time, a setting on whether the transfer should be notified, a setting of a notification destination of the notification, and the like may be performed. Plural types may be set out of FAX, iFAX, E-mail, and file saving as transfer types or an arbitrary combination of the transfer types may be set. As other settings, it is also possible to provide a setting on presence or absence of reception printing at transfer time, a setting on whether a list indicating that data is transferred should be outputted at transfer time, and a setting on whether transfer of data should be notified.

Transfer processing for received facsimile data executed by the CPU 11 will be explained using a flowchart shown in FIG. 14.

When the MFP 1 receives facsimile data from the facsimile 7 via the PSTN 6, the determining unit 111 of the CPU 11 determines whether a TSI transfer function based on a setting in the TSI transfer box is set as valid by the user (step S100). When the TSI transfer function is not valid (step S100, NO), the CPU 11 determines whether a transfer setting without SUB is applied to the facsimile data received by the MFP 1 (step S101). When the transfer setting without SUB is applied (step S101, YES), the CPU 11 transfers the facsimile data in accordance with the transfer setting without SUB (step S102). Since the transfer setting in this case is a transfer setting for a case in which the TSI transfer function is not valid, all facsimile data received are set to be transferred to a specific place. When the transfer setting is not applied (step S101, NO), the CPU 11 subjects the facsimile data to output processing in the printer 17 of the MFP 1 (step S103).

When the TSI transfer function is valid (step S100, YES), the CPU 11 determines whether a TSI transfer box is registered in the storing unit 14 (step S104). When the CPU 11 determines that a TSI transfer box is not registered (step S104, NO), the CPU 11 determines whether a transfer setting without SUB is applied to the facsimile data (step S101). When the CPU 11 determines that the TSI transfer box is registered (step S104, YES), the deleting unit 112 of the CPU 11 deletes data of characters and the like except numerals from TSI and the CPU 11 calculates na, which is the number of digits of the TSI after the deletion of the data of characters and the like except numerals (step S105). The TSI after deleting data of characters and the like except numerals is referred to as TSI after deletion. The CPU 11 determines whether na is larger than zero (step S106). When it is determined that na is larger than zero (step S106, YES), the searching unit 113 of the CPU 11 searches, in order for each of TSI transfer boxes, whether a telephone number coinciding with the TSI after deletion created by the deleting unit 112 of the CPU 11 from the TSI of the received facsimile data is set in transmission source telephone number lists set in the TSI transfer boxes (step S107). When the searching unit 113 of the CPU 11 determines that a number coinciding with the TSI after deletion is not in a transmission source telephone number list set in a first TSI transfer box (step S108, NO), the CPU 11 determines whether a second TSI transfer box is set (step S109). When the determining unit 111 of the CPU 11 determines that the second TSI transfer box is not set (step S09, NO), the CPU 11 determines whether a transfer setting without SUB is applied to the facsimile data received by the MFP 1 (step S101). When the CPU 11 determines that the second TSI transfer box is set (step S109, YES), the searching unit 113 of the CPU 11 searches, in order for each of TSI transfer boxes, whether a telephone number coinciding with the TSI after deletion created by the deleting unit 112 of the CPU 11 from the TSI of the received facsimile data is set in transmission source telephone number lists set in the TSI transfer boxes (step S107).

When the searching unit 113 of the CPU 11 finds that the telephone number coinciding with the TSI after deletion is set in the transmission source telephone number list set in any one of the TSI transfer boxes (step S108, YES), the CPU 11 transfers the facsimile data to a transfer destination set in the TSI transfer box in which the telephone number coinciding with the TSI after deletion is set (step S110). The CPU 11 determines, on the basis of a print setting set in the TSI transfer box in which the telephone number coinciding with the TSI after deletion is set, whether the facsimile data subjected to transfer processing should be printed in the MFP 1 as well (step S111). When the print setting is made (step S111, YES), the CPU 11 subjects the facsimile data to output processing with the printer 17 of the MFP 1 (step S112). If the print setting is not made (step S111, NO), the CPU 11 does not subject the facsimile data to output processing with the printer 17 of the MFP 1 (step S112).

Actions at the time when the MFP 1 constituted as described above receives facsimile data not affixed with SUB from the facsimile 7 will be explained. When the searching unit 113 of the MFP 1 receives facsimile data from the facsimile 7, the searching unit 113 searches in which of the TSI transfer boxes a transmission source telephone number coinciding with the telephone number “0331234567” of TSI affixed to the facsimile data is set. In this case, when data of a space, a sign, and a character are included in the TSI, the searching unit 113 of the CPU 11 executes search for the transmission source telephone number after deleting these data. The CPU 11 of the MFP 1 transfers, with facsimile transmission, the facsimile data to a transfer destination set in the TSI transfer box in which the transmission source telephone number “0331234567” is set.

According to the MFP 1 in this embodiment, when facsimile data is transmitted from a facsimile via the PSTN 6, if there is a transmission source telephone number set in a TSI transfer box coinciding with a number indicated by TSI affixed to the facsimile data, transfer of the facsimile data is performed in accordance with a transfer setting set in the TSI transfer box. Therefore, when a sender transmits facsimile data, even if the sender is not conscious of causing a reception side apparatus to transfer the facsimile data, the reception side apparatus can transfer the facsimile data according to a transmission source.

In TSI of facsimile data received by the MFP 1, not only a telephone number but also a space, a sign, and a character may be mixed and transmitted. Even in this case, when the searching unit 113 of the MFP 1 searches for a TSI transfer box in which a transmission source telephone number is set, the searching unit 113 searches for a TSI transfer box number in which the transmission source telephone number is set after deleting data of the space, the sign, and the character not used in the telephone number. Therefore, the CPU 11 of the MFP 1 can accurately create a telephone number (including only numerals) from the TSI of the received facsimile data and search for a TSI transfer box in which the transmission source telephone number is set.

When facsimile data received by the MFP 1 is transferred, it is determined in the MFP 1, in accordance with a print setting of a TSI transfer box in which a transmission source telephone number is set, whether the facsimile data should be printed. Therefore, since only a specific transfer destination can acquire facsimile data transmitted from a specific transmission source, it is possible to impart confidentiality to the facsimile data. In the above explanation, the example at the time when transfer setting for reception facsimile data in the control panel 23 of the MFP 1 is performed is described. However, it is also possible to perform transfer setting for reception facsimile data of an MFP from a PC connected to the MFP via a network. A transfer destination is not limited to one and may be combinations of file saving, E-mail transmission, iFAX transmission, and FAX transmission.

The invention provides an MFP that uses TSI in which a local number is included and can create a transmission source telephone number list in a TSI transfer box and transfer received facsimile data according to a transmission source. Therefore, the transmission source does not need to be conscious that the facsimile data is transferred. A reception side can set a transfer destination for each transmission source according to convenience on the reception side and transfer a received facsimile without being noticed by the transmission source. When a transmission source telephone number of a TSI transfer box is set, the user only has to check a telephone number of a transmission source described in a reception management report (journal) and set the telephone number in a transmission source telephone number of the TSI transfer box. For example, it is possible to easily perform an operation for transferring an order by facsimile data from a specific customer to a PC. In that case, it is possible to set the MFP 1 not to receive and print the facsimile data at the time of the transfer of the facsimile data. Therefore, the MFP 1 can impart confidentiality to the facsimile data received from the specific transmission source. It is possible to set plural telephone numbers in a transmission source telephone number list set in the TSI transfer box. Therefore, even if the MFP 1 receives facsimile data from plural transmission sources, which are in an identical trader but telephone numbers of which do not have coinciding parts, it is possible to transfer the facsimile data to one same transfer destination.

Moreover, the user can set a telephone number of a transmission source, from which the user does not wish to receive facsimile data, as a transmission source telephone number of a specific TSI transfer box and set a folder of a PC as a transfer destination for spam facsimile. With such a setting, when the user does not wish to receive direct mails from unexpected senders, it is possible to delete the direct mails without looking at contents of folders thereof and prevent the user from performing reception printing at transfer time.

Additional advantages and modifications will readily occur those skilled in the art. Therefore, the invention in its broader aspects is not limited to the specific details and representative embodiments shown and described herein. Accordingly, various modifications may be made without departing from the spirit or scope of the invention as defined by the appended claims and equivalents thereof.

What is claimed is:

1. An image forming apparatus comprising:
a receiving unit configured to receive first facsimile data affixed with first transmission station identification data;
a storing unit configured to store a transfer box in which an identification code based on one or more transmission station identification data and a transfer destination for facsimile data corresponding to the identification code are set;
a searching unit configured to search whether a first identification code based on the first communication station identification data is included in the identification code set in the transfer box stored in the storing unit; and
a transferring unit configured to transfer the first facsimile data to the transfer destination when the searching unit finds a second identification code coinciding with the first identification code from the identification code.

2. An image forming apparatus according to claim 1, further comprising a deleting unit configured to delete data except numerals from the first transmission station identification data to create the first identification code.

3. An image forming apparatus according to claim 2, wherein the identification code, the first identification code, and the second identification code are formed by only numerals.

4. An image forming apparatus according to claim 1, further comprising a setting unit configured to set, when the transfer unit transfers the facsimile data, whether the facsimile data should be printed.

5. An image forming apparatus according to claim 1, wherein the transmission station identification data is TSI.

6. An image forming apparatus according to claim 1, wherein the transfer destination is at least one of FAX, iFAX, E-mail, and file saving.

7. An image forming apparatus comprising:
receiving means for receiving first facsimile data affixed with first transmission station identification data;
storing means for storing a transfer box in which an identification code based on one or more transmission station identification data and a transfer destination for facsimile data corresponding to the identification code are set;
searching means for searching whether a first identification code based on the first communication station identification data is included in the identification code set in the transfer box stored in the storing means; and
transferring means for transferring the first facsimile data to the transfer destination when the searching means finds a second identification code coinciding with the first identification code from the identification code.

8. An image forming apparatus according to claim 7, further comprising deleting means for deleting data except numerals from the first transmission station identification data to create the first identification code.

9. An image forming apparatus according to claim 8, wherein the identification code, the first identification code, and the second identification code are formed by only numerals.

10. An image forming apparatus according to claim 7, further comprising setting means for setting, when the transfer means transfers the facsimile data, whether the facsimile data should be printed.

11. An image forming apparatus according to claim 7, wherein the transmission station identification data is TSI.

12. An image forming apparatus according to claim 7, wherein the transfer destination is at least one of FAX, iFAX, E-mail, and file saving.

13. An image forming method:
storing a transfer box in which an identification code based on one or more transmission station identification data and a transfer destination for facsimile data corresponding to the identification code are set;
receiving first facsimile data affixed with first transmission station identification data;
searching whether a first identification code based on the first communication station identification data is included in the identification code set in the transfer box; and
transferring the first facsimile data to the transfer destination when a second identification code coinciding with the first identification code is found from the identification code.

14. An image forming method according to claim 13, further comprising deleting data except numerals from the first transmission station identification data to create the first identification code.

15. An image forming method according to claim 14, wherein the identification code, the first identification code, and the second identification code are formed by only numerals.

16. An image forming method according to claim 13, further comprising setting, when the facsimile data is transferred, whether the facsimile data should be printed.

17. An image forming method according to claim 13, wherein the transmission station identification data is TSI.

18. An image forming method according to claim 13, wherein the transfer destination is at least one of FAX, iFAX, E-mail, and file saving.
